(19) United States
(12) Patent Application Publication
(10) Pub. No.: US 2020/0278241 A1
(43) Pub. Date: Sep. 3, 2020

(54) VIBRATION DETERMINATION DEVICE, VIBRATION DETERMINATION METHOD, AND PROGRAM

(71) Applicant: NEC CORPORATION, Tokyo (JP)

(72) Inventors: Yu KIYOKAWA, Tokyo (JP); Shigeru KASAI, Tokyo (JP); Shohei KINOSHITA, Tokyo (JP)

(73) Assignee: NEC CORPORATION, Tokyo (JP)

(21) Appl. No.: 16/648,092

(22) PCT Filed: Sep. 21, 2017
(86) PCT No.: PCT/JP2017/034070

§ 371 Date: Mar. 17, 2020

(51) Int. Cl. G01H 17/00

(52) U.S. Cl. CPC G01H 17/00

(57) ABSTRACT

A vibration determination device according to an exemplary aspect of the present invention includes: at least one memory storing a set of instructions; and at least one processor configured to execute the set of instructions to: determine, based on a plurality of feature values representing features of a vibration of a structure, whether the vibration of the structure is a standard vibration; and detect, when it is not determined that the vibration of the structure is the standard vibration, an outlier included in the plurality of feature values; determine, based on the plurality of feature values other than the detected outlier, whether the vibration of the structure is the standard vibration; and output whether the vibration of the structure is the standard vibration.

### TECHNICAL FIELD

The present disclosure relates to a technique for analyzing a vibration, and particularly, relates to a technique for analyzing a vibration of a structure.

### BACKGROUND ART

A vibration characteristic of a structure such as a case and a printed board of a personal computer, or a frame of an automobile is effective for design, evaluation, and the like of structural units thereof. The vibration characteristic for use in design and evaluation of the structural units is, for example, a natural vibration frequency and a damping rate in a particular natural vibration mode of the structure. A vibration of the structure is measured by, for example, a sensor such as a displacement, speed, or acceleration sensor arranged on a surface or the like of the structure. The natural vibration mode indicates how a vibration appears in an object vibrating at the natural vibration frequency. How a vibration appears, that is, the natural vibration mode is represented by, for example, a spatial distribution of vibration amplitude of the object vibrating at the natural vibration frequency. For example, when a plurality of sensors are arranged on a surface of the structure and a vibration is measured by those sensors, the vibration of the structure is represented by, for example, a vector including, as an element, amplitude of the vibration measured by those sensors. In general, a structure has a plurality of natural vibration modes. The vibration of the structure is represented by superposition of the plurality of natural vibration modes. When a distribution of positions of vibration amplitude indicating the natural vibration modes of the structure is represented by vectors, a vector representing the vibration of the structure is represented by a linear sum of the vectors representing the natural vibration modes of the structure. The natural vibration frequency of the vibration of the structure is an eigenvalue. The vector representing the natural vibration mode of the structure at the natural vibration frequency is an eigenvector related to the natural vibration frequency of the vibration of the structure. As described above, the eigenvector represents a distribution of positions of vibration amplitude of a natural vibration indicated by the natural vibration mode. As described above, the vibration characteristic of the structure can be represented by the eigenvector, the natural vibration frequency, and the damping rate.

An actual vibration of the structure has various vibration modes. In design and evaluation of the structure, it is difficult to evaluate the vibration characteristic unless the vibration modes of the structure are the same.

PTL 1 discloses one example of a determination method of determining whether a vibration mode of a structure is the same as a vibration mode of interest. The method in PTL 1 determines whether a vibration mode to be determined is the vibration mode of interest, by using a mode correlation coefficient between an eigenvector of the vibration mode of interest and an eigenvector of the vibration mode to be determined.

### CITATION LIST

### Patent Literature

[PTL 1] Japanese Patent No. 4626351

### SUMMARY OF INVENTION

### Technical Problem

As described above, a vibration of a structure is measured by, for example, a sensor attached to a surface of the structure. When the sensor has an abnormality such as, for example, deterioration or failure, and when a place to which the sensor is attached has an abnormality such as, for example, cracking, it is impossible to acquire a normal measurement value as a vibration measurement value by using the sensor. The normal measurement value is a measurement value when, for example, the sensor is normal and the place to which the sensor is attached is normal. An abnormal measurement value will be hereinafter denoted as an abnormal value. When measurement values measured in a vibration mode to be determined include an abnormal value, the above-described mode correlation coefficient decreases due to the abnormal value, in comparison with a case in which the measurement values include no abnormal value, even when the vibration mode to be determined of the structure is a vibration mode of interest. Even when the vibration mode to be determined is the vibration mode of interest, the vibration mode to be determined may not be determined as the vibration mode of interest.

One object of the present disclosure is to provide a vibration determination device and the like which can improve vibration determination performance when measurement values of a vibration include an abnormality.

### Solution to Problem

A vibration determination device according to an exemplary aspect of the present invention includes: determination means for determining, based on a plurality of feature values representing features of a vibration of a structure, whether the vibration of the structure is a standard vibration; and detection means for detecting, when it is not determined that the vibration of the structure is the standard vibration, an outlier included in the plurality of feature values, wherein the determination means further determines, based on the plurality of feature values other than the detected outlier, whether the vibration of the structure is the standard vibration, and the vibration determination device further comprises output means for outputting whether the vibration of the structure is the standard vibration.

A vibration determination method according to an exemplary aspect of the present invention includes: determining, based on a plurality of feature values representing features of a vibration of a structure, whether the vibration of the structure is a standard vibration; detecting, when it is not determined that the vibration of the structure is the standard vibration, an outlier included in the plurality of feature values; determining, based on the plurality of feature values other than the detected outlier, whether the vibration of the structure is the standard vibration; and outputting whether the vibration of the structure is the standard vibration.

A storage medium according to an exemplary aspect of the present invention stores a program causing a computer to execute: determination processing of determining, based on a plurality of feature values representing features of a vibration of a structure, whether the vibration of the structure is a standard vibration; and detection processing of detecting, when it is not determined that the vibration of the structure is the standard vibration, an outlier included in the plurality of feature values, wherein the determination processing further determines, based on the plurality of feature values other than the detected outlier, whether the vibration of the structure is the standard vibration, and the program further causes a computer to execute output processing of outputting whether the vibration of the structure is the standard vibration. An exemplary aspect of the present invention can be achieved by the program stored in the storage medium described above.

### Advantageous Effects of Invention

The present disclosure has an advantageous effect of enabling improving vibration determination performance when measurement values of a vibration include an abnormality.

### BRIEF DESCRIPTION OF DRAWINGS

FIG. 1 is a block diagram representing an example of a configuration of a vibration determination device according to a first example embodiment of the present disclosure.

FIG. 2 is a block diagram representing an example of a configuration of a vibration determination system according to the first example embodiment of the present disclosure.

FIG. 3 is a diagram schematically illustrating an example of a structure having a plurality of sensors attached thereto and having no damage such as peeling.

FIG. 4 is a diagram schematically representing amplitude of a vibration based on measurement data acquired when the structure having no damage such as peeling is vibrated.

FIG. 5 is a diagram schematically illustrating an example of a structure having a plurality of sensors attached thereto and having peeling.

FIG. 6 is a diagram schematically representing amplitude of a vibration based on measurement data acquired when the structure having peeling is vibrated.

FIG. 7 is a flowchart representing an example of an operation of the vibration determination device according to the first example embodiment of the present disclosure.

FIG. 8 is a flowchart representing an example of an operation of the vibration determination device according to the first example embodiment of the present disclosure.

FIG. 9 is a flowchart representing an example of an operation of determination processing performed by the vibration determination device according to the first example embodiment of the present disclosure.

FIG. 10 is a block diagram representing an example of a configuration of a vibration determination device according to a second example embodiment of the present disclosure.

FIG. 11 is a flowchart representing an example of an operation of the vibration determination device according to the second example embodiment of the present disclosure.

FIG. 12 is a flowchart representing an example of an overall operation of the vibration determination device according to the second example embodiment of the present disclosure.

FIG. 13 is a block diagram representing a configuration of a vibration determination device according to a third example embodiment of the present disclosure.

FIG. 14 is a flowchart representing an example of an operation of the vibration determination device according to the third example embodiment of the present disclosure.

FIG. 15 is a diagram representing one example of a hardware configuration of a computer that can achieve the vibration determination device according to the example embodiments of the present disclosure.

### EXAMPLE EMBODIMENT

Hereinafter, example embodiments of the present disclosure will be described in detail with reference to the drawings.

### First Example Embodiment

[Description of Configuration]

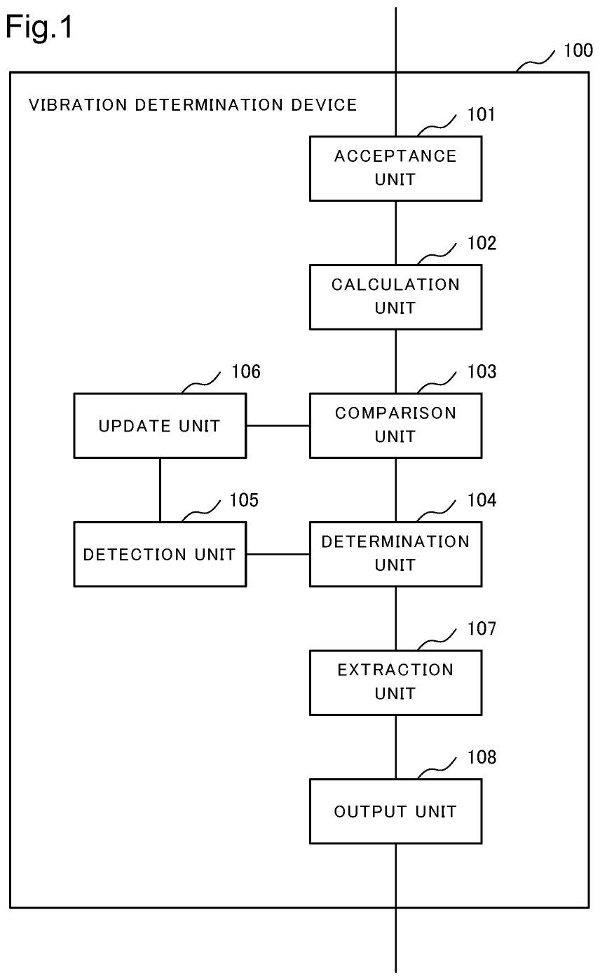

FIG. 1 is a block diagram representing an example of a configuration of a vibration determination device according to a first example embodiment of the present disclosure. A vibration determination device 100 illustrated in FIG. 1 includes a reception unit 101, a calculation unit 102, a comparison unit 103, a determination unit 104, a detection unit 105, an update unit 106, an extraction unit 107, and an output unit 108.

The acceptance unit 101 accepts, for example, measurement data acquired by measuring a vibration with a plurality of sensors installed at different places on a structure, and representing transition of the vibration of the structure. The structure is an object that may vibrate, such as a case or a printed board of a personal computer, or a frame of an automobile. The structure may be an architectural structure such as a bridge. The structure is not limited to the above-described examples. The sensor is, for example, a displacement sensor, a speed sensor, an acceleration sensor, or the like. The measurement data are, for example, data representing transition of the vibration of the structure and being represented by displacement, speed, acceleration, or the like of a place on the vibrated structure to which the sensor is attached, the displacement, speed, acceleration, or the like is measured by the above-described sensor at a predetermined period. The post-vibration transition of the vibration of the vibrated structure is called a vibration response. The measurement data are, for example, a row of measurement values measured by the sensor, the measurement values being arranged in order of measurement time of each sensor. In the following description, the measurement data will be also denoted as a series of measurement values and time-history waveform data. A set of measurement data acquired by the plurality of sensors will be also denoted as a measurement dataset. In this case, the measurement dataset is a plurality of series of measurement values. The measurement dataset includes data representing the vibration response.

The acceptance unit 101 may be connected with the sensor, and may receive a signal indicating transition of a measurement value from the sensor. The acceptance unit 101 may transform the received signal into the above-described time-history waveform data. The acceptance unit 101 may be connected with a device such as a data logger that stores the measurement dataset measured by the sensor, and may receive the measurement dataset from the device such as a data logger.

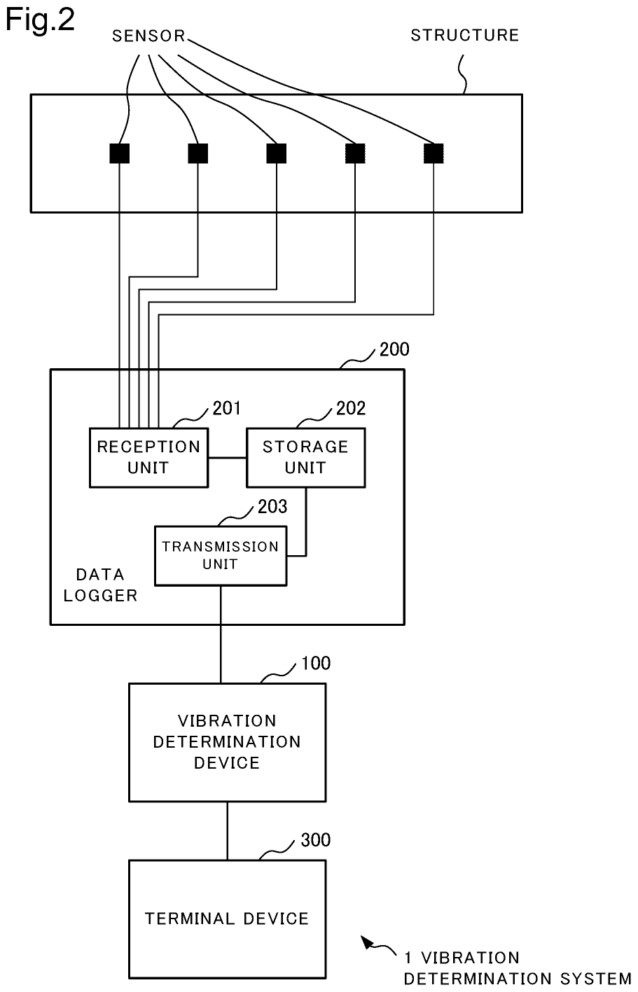

FIG. 2 is a block diagram representing an example of a configuration of a vibration determination system according to the first example embodiment of the present disclosure. A vibration determination system 1 illustrated in FIG. 2 includes the vibration determination device 100, a data logger 200, and a terminal device 300. The vibration determination device 100 is communicably connected with the data logger 200 and the terminal device 300.

The data logger 200 includes a reception unit 201, a storage unit 202, and a transmission unit 203. The reception unit 201 receives, for example, a signal indicating transition of a measurement value from the sensor attached to the structure. The signal may be a digital signal or an analog signal. The reception unit 201 transforms the received signal into, for example, data of the above-described time-history waveform data in a computer-treatable format, and stores the transformed data in the storage unit 202. The storage unit 202 stores the time-history waveform data. The transmission unit 203 reads out, for example, in response to a request from the vibration determination device 100, the time-history waveform data stored in the storage unit 202, and transmits the read-out time-history waveform data to the vibration determination device 100.

The terminal device 300 receives information (for example, a vibration characteristic of the structure, as will be described later) from the vibration determination device 100, and outputs the received information. The terminal device 300 is, for example, a computer including a communication interface, a display unit such as a display, an input unit such as a keyboard, and the like. The terminal device 300 displays, for example, on the display unit, for example, the information received from the vibration determination device 100 via the communication interface.

An operator of the vibration determination system 1 may apply a vibration to the structure ascertained as having no damage or deterioration such as peeling or cracking. The operator may measure the structure vibrating due to the applied vibration, with a sensor ascertained as having no failure or attachment fault. A method of applying a vibration to the structure by an operator may be a method set in such a way that the structure vibrates in a natural vibration mode by which, for example, a vibration characteristic for use in design and evaluation of the structure can be acquired, among a plurality of natural vibration modes of the structure. The operator may record a measured measurement dataset by using a data logger. Such a measurement dataset will be hereinafter denoted as a standard dataset. Measurement data included in the standard dataset will be also denoted as standard data. A measurement value included in the standard data will be also denoted as a standard measurement value. The standard data are a series of standard measurement values. The standard dataset is a set of a plurality of pieces of standard data, that is, a plurality of series of standard measurement values. The standard dataset represents transition of the vibration in a standard natural vibration mode of the structure. A vibration mode of the structure when the measurement data in the standard dataset are measured will be denoted as a standard natural vibration mode. The reception unit 201 may receive a signal indicating a standard dataset, may transform the received signal into the standard dataset, and may store the acquired standard dataset in the storage unit 202. The transmission unit 203 may read out the standard dataset from the storage unit 202, and may transmit the read-out standard dataset to the vibration determination device 100. The transmission unit 203 may transmit, in response to a request of the standard dataset from the vibration determination device 100, the standard dataset to the vibration determination device 100. The structure on which measurement of the standard dataset is performed may be a structure of the same quality and the same shape as the structure on which the above-described measurement of the measurement dataset is performed. The structure on which measurement of the standard dataset is performed may be a structure before occurrence of a change in a state such as failure of the sensor or damage or deterioration of the structure, on which the above-described measurement of the measurement dataset is performed.

The acceptance unit 101 further accepts the standard dataset. The acceptance unit 101 may request, for example, the data logger 200 for the standard dataset, when the vibration determination device 100 starts an operation.

The calculation unit 102 calculates a feature (for example, an eigenvector to be described later) of the vibration of the structure, from data (that is, the measurement dataset) representing transition of the vibration of the structure. The calculation unit 102 sends the calculated feature of the vibration of the structure to the comparison unit 103. The calculation unit 102 may preliminarily calculate a feature (for example, a standard eigenvector to be described later) of the vibration in the standard natural vibration mode of the structure, from data (that is, the standard dataset) representing transition of the vibration in the standard natural vibration mode of the structure. The calculation unit 102 may send the calculated feature of the vibration in the standard natural vibration mode of the structure to the comparison unit 103.

Specifically, the calculation unit 102 specifies a section (hereinafter, denoted as a damped section) representing a portion where the vibration of the structure caused by the applied vibration is damped, among a row of measurement values included in the time-history waveform data received by the acceptance unit 101. In other words, the calculation unit 102 specifies a portion representing the vibration response. The calculation unit 102 may specify, for example, a section of a predetermined length representing the vibration response, among a row of measurement values. The calculation unit 102 may specify a peak of amplitude in a row of measurement values, and may specify, as the portion representing the vibration response, a predetermined number of values successive from a value measured a predetermined period of time after a value of the specified peak is measured. The calculation unit 102 transforms the measurement data of the damped section into frequency-domain data for each sensor used in measurement, by performing, for example, Fourier transform in relation to time for each sensor. The calculation unit 102 may perform, for example, fast Fourier transform on the measurement data of the damped section, that is, on a row of measurement values. The calculation unit 102 may transform the measurement data into frequency-domain data by using, for example, another transform such as Z-transform or Hilbert transform. The calculation unit 102 detects a peak of a frequency spectrum in the post-transform frequency-domain data. The calculation unit 102 may detect, for example, a frequency at which magnitude of a vector including, as an element, an amplitude value for an identical frequency of each sensor reaches a peak. A range of the frequency for which the calculation unit 102 calculates a peak may be preliminarily determined. The calculation unit 102 may calculate, as an eigenvector, a normalized vector of the above-described vector at the detected frequency. The calculation unit 102 sends the calculated eigenvector to the comparison unit 103.

For example, description will be given of a vibration when the structure is a beam of a length L extending in an x-axis direction, both ends of the beam are fixed, and a free damping vibration is generated in the beam by applying a vibration to the beam. A time-history waveform of z-direction deflective displacement acquired from the displacement sensor installed at a position on the structure indicated by a coordinate x (0<x<L) can be approximated by the following expression.

$$w ( x , t ) = {\sum }_{n = 1}^{N} {φ}_{n} ( x ) {A}_{n} cos ( {ω}_{n} \sqrt{1 - {λ}_{n} / {ω}_{n}} t + {Φ}_{n} ) {e}^{- {λ}_{n} t} \qquad [ Math . 1 ]$$

Herein, the function w(x,t) is deflective displacement at a time t and a position x. The function ϕₙ(x) is an eigenfunction representing a n-th natural vibration mode. The value Aₙ is initial vibration amplitude. The value λₙ is a damping rate of the n-th natural vibration mode. The value ωₙ is a natural angular frequency of the n-th natural vibration mode. The value Φₙ is an initial phase of the n-th natural vibration mode. A natural vibration frequency is a value acquired by dividing a natural angular frequency by 2π. An eigenvector is generated by aligning values of eigenfunctions at a plurality of positions. For example, k sensor positions when k displacement sensors are attached on the x-axis set for the structure being the beam are denoted by x₁, x₂, . . . , xₖ. In this case, an eigenvector |ϕₙ> in the case of the n-th natural vibration mode is denoted by |ϕₙ>=^{t}((ϕₙ(x₁), ϕₙ(x₂), . . . , ϕₙ(xₖ)). The function acquired by performing Fourier transform with time t on the time-history waveform w(x,t) of the deflective displacement is denoted by F(f,x).

The natural vibration frequency is a frequency at which a frequency spectrum acquired by performing Fourier transform on the function w(x,t) representing the time-history waveform of the deflective displacement reaches a peak.

When f is regarded as a constant, F(f,x) is represented by a linear combination of eigenfunctions ϕₙ(x). Thus, the eigenvector representing amplitude of a natural vibration at a plurality of positions can be acquired by normalizing a vector including, as elements, values at the plurality of positions of the function acquired by performing Fourier transform on the function w(x,t).

For example, when positions of the k displacement sensors attached on the x-axis set for the beam are denoted by x₁, x₂, . . . , xₖ, the eigenvector (|ϕₙ>) representing a natural vibration at a position of a displacement sensor in the case of the n-th natural vibration mode is |ϕ_{n>=}1/Z ^{t(F(ω}ₙ,x₁), F(ωₙ,x₂), . . . , F(ωₙ,xₖ)). Z is a normalization factor, and is set in such a way that an inner product <ϕₙ|ϕₙ> becomes <ϕₙ|ϕₙ>=1.

The function w(x,t) indicated in Math. 1 is an example in the case of the beam of the structure, and an expression indicating a vibration of another structure is different from the expression indicated in Math. 1. According to the present example embodiment, the above-described measurement dataset is equivalent to the function w(x,t). The frequency-domain data acquired by transforming, by using Fourier transform or the like, the measurement data included in the measurement dataset and measured by a plurality of sensors are equivalent to the function F(f,x).

When the structure is a board, the calculation unit 102 may calculate the eigenfunction, the natural vibration frequency, and the eigenvector according to, for example, a method described in Document “Yoshio ADACHI, ‘Dynamic Response in Infrasonic Frequency Range of Highway Bridge Deck Slabs’, Journal of Japan Society of Civil Engineers, vol. 330, February 1983, Japan Society of Civil Engineers”, regarding the eigenfunction or the natural vibration frequency. The above description is merely an example. The calculation unit 102 may calculate the eigenvector of the structure according to another method.

When the acceptance unit 101 receives a standard dataset, the calculation unit 102 similarly calculates an eigenvector from the received standard dataset. The eigenvector calculated from the standard dataset will be denoted as a standard eigenvector. When, for example, a model of the structure represented by the expression indicated in Math. 1 is known, the calculation unit 102 may calculate the standard eigenvector by numerical computation on the basis of the model of the structure. In this case, an operator of the vibration determination system 1 may preliminarily input data representing positions of sensors, to the vibration determination device 100 via, for example, the terminal device 300. The calculation unit 102 sends the calculated standard eigenvector to the comparison unit 103.

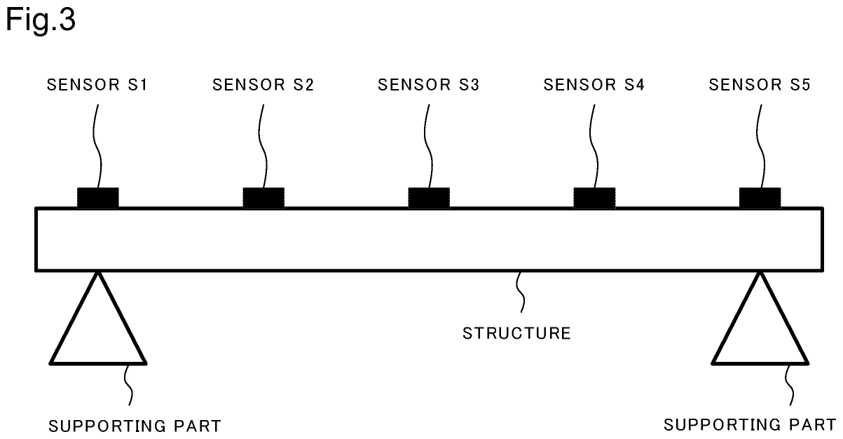

FIG. 3 is a diagram schematically illustrating an example of a structure having a plurality of sensors attached thereto and having no damage such as peeling. In the example illustrated in FIG. 3, five sensors (a sensor S1, a sensor S2, a sensor S3, a sensor S4, and a sensor S5) are attached to the structure.

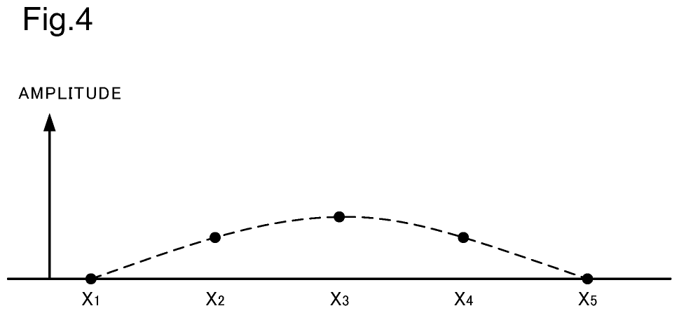

FIG. 4 is a diagram schematically representing amplitude of a vibration based on measurement data acquired when the structure illustrated in FIG. 3 having no damage such as peeling is vibrated. X1 to X5 illustrated in FIG. 4 respectively represent positions to which the sensors S1 to S5 are attached. The vertical axis in FIG. 4 represents magnitude of amplitude. The black dots illustrated in FIG. 4 respectively represent amplitude of a vibration measured by the sensors S1 to S5. The standard eigenvector of the structure illustrated in FIG. 3 is, for example, a vector including, as elements, values of amplitude indicated by the black dots illustrated in FIG. 4.

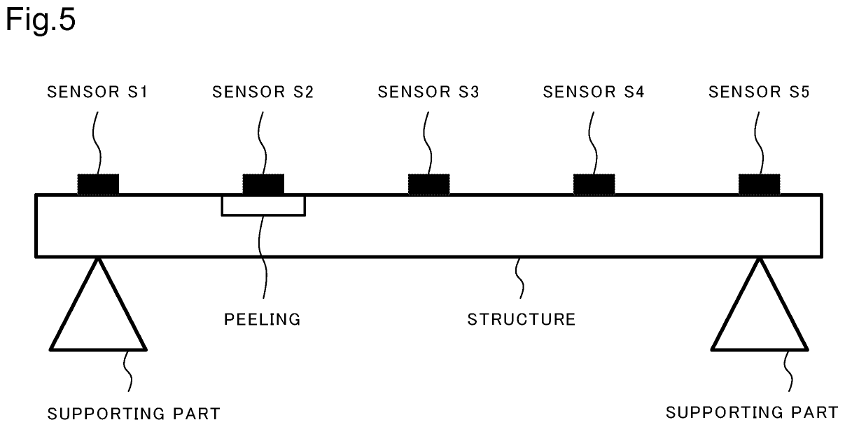

FIG. 5 is a diagram schematically illustrating an example of a structure having a plurality of sensors attached thereto and having peeling. Also in the example illustrated in FIG. 5, five sensors (a sensor S1, a sensor S2, a sensor S3, a sensor S4, and a sensor S5) are attached to the structure. In the example illustrated in FIG. 5, a place to which the sensor S2 is attached has peeling. The structure illustrated in FIG. 5 is equal to the structure illustrated in FIG. 3, except for presence of the peeling. When the structure illustrated in FIG. 5 is vibrated, a vibration equal to a vibration generated when the structure illustrated in FIG. 3 is vibrated is generated in the structure illustrated in FIG. 5, except for the place of the peeling.

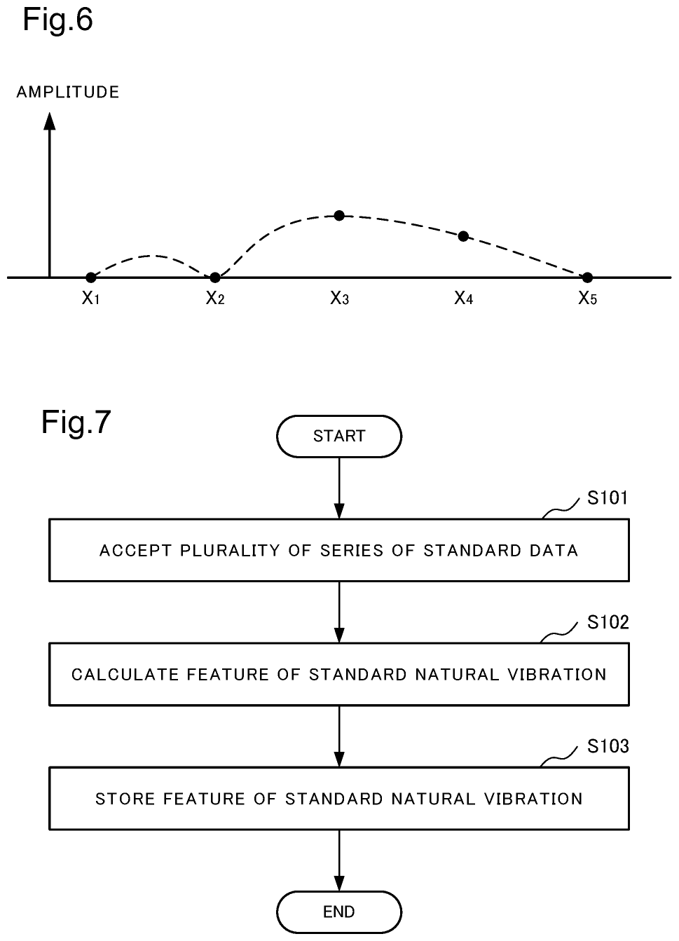

FIG. 6 is a diagram schematically representing amplitude of a vibration based on measurement data acquired when the structure illustrated in FIG. 5 having peeling is vibrated. X1 to X5 illustrated in FIG. 6 respectively represent positions to which the sensors S1 to S5 are attached. The vertical axis in FIG. 6 represents magnitude of amplitude.

The black dots drawn in FIG. 6 respectively represent amplitude of a vibration measured by the sensors S1 to S5. In the example illustrated in FIG. 6, the amplitude of the vibration at the place indicated by X2 is 0. Even when the structure is vibrated, the place indicated by X2, to which the sensor S2 is attached, does not vibrate due to the peeling. The amplitude of the vibration at the places indicated by X1, X3, X4, and X5 is equal to the amplitude of the vibration at the places indicated by X1, X3, X4, and X5 illustrated in FIG. 4. The standard eigenvector of the structure illustrated in FIG. 5 is, for example, a vector including, as elements, values of amplitude indicated by the black dots illustrated in FIG. 6. The amplitude may be complex amplitude including phase information.

The comparison unit 103 receives a feature (specifically, for example, the above-described standard eigenvector) of the vibration in the standard natural vibration mode of the structure from the calculation unit 102, and stores the received feature (for example, the standard eigenvector) of the vibration in the standard natural vibration mode of the structure. The comparison unit 103 further receives a feature (specifically, for example, the eigenvector) of the measured vibration of the structure from the calculation unit 102. The comparison unit 103 compares the feature of the measured vibration of the structure with the feature of the vibration in the standard natural vibration mode of the structure. Specifically, the comparison unit 103 compares the received target eigenvector with the standard eigenvector. Hereinafter, the eigenvector to be compared with the standard eigenvector will be denoted as a target eigenvector. More specifically, the comparison unit 103 calculates a value indicating a correlation between the standard eigenvector and the target eigenvector. The value indicating the correlation is, for example, a modal assurance criterion (MAC).

The MAC is represented by the following expression. In the following expression, |ϕ> represents the standard eigenvector, and |ψ> represents the target eigenvector.

$$MAC = \frac{{〈 φ \vert ψ 〉}^{2}}{〈 φ \vert φ 〉 〈 ψ \vert ψ 〉} \qquad [ Math . 2 ]$$

The comparison unit 103 sends, to the determination unit 104, a result of comparison of the feature of the measured vibration of the structure with the feature of the vibration in the standard natural vibration mode of the structure. Specifically, the comparison unit 103 may send the above-described MAC to the determination unit 104.

The determination unit 104 determines, on the basis of the result of comparison of the feature of the measured vibration of the structure with the feature of the vibration in the standard natural vibration mode of the structure, whether the measured vibration of the structure has the feature of the vibration in the standard natural vibration mode of the structure.

As described above, the feature of the measured vibration of the structure is represented by, for example, the target eigenvector indicating the natural vibration mode of the measured vibration of the structure. The feature of the vibration in the standard natural vibration mode of the structure is represented by, for example, the standard eigenvector representing the standard natural vibration mode. A matter that the measured vibration of the structure has the feature of the vibration in the standard natural vibration mode of the structure indicates that the vibration of the structure is the vibration in the standard natural vibration mode. The result of comparison of the feature of the measured vibration of the structure with the feature of the vibration in the standard natural vibration mode of the structure is, specifically, the value (for example, the MAC) representing the correlation between the target eigenvector and the standard eigenvector.

For example, when the correlation between the target eigenvector and the standard eigenvector is higher than a predetermined criterion, the target eigenvector can be regarded as the standard eigenvector, that is, the vibration of the structure can be regarded as the vibration in the standard natural vibration mode. When the correlation between the target eigenvector and the standard eigenvector is higher than a predetermined criterion, the determination unit 104 determines that the vibration of the structure is the vibration in the standard natural vibration mode, that is, the measured vibration of the structure has the feature of the vibration in the standard natural vibration mode of the structure. Specifically, when the correlation value (for example, the above-described MAC) representing the correlation between the target eigenvector and the standard eigenvector is equal to or greater than a predetermined threshold value C, the determination unit 104 determines that the vibration of the structure is the vibration in the standard natural vibration mode. The threshold value C may be, for example, 0.8. The threshold value C may be, for example, 0.9. The value of the threshold value C is not limited to the above examples. The value of the threshold value C may be set, for example, according to a purpose.

The determination unit 104 may include the comparison unit 103. The vibration determination device 100 does not need to include the comparison unit 103, and the determination unit 104 may operate as the comparison unit 103. According to the present example embodiment, the comparison unit 103 and the determination unit 104 are described as separate units.

When it is determined that the measured vibration of the structure does not have the feature of the vibration in the standard natural vibration mode of the structure, that is, when the correlation value is smaller than the threshold value C, there is a possibility that the measured vibration of the structure is the vibration in the standard natural vibration mode of the structure, but some pieces of measurement data may be abnormal. Abnormal measurement data refers to, for example, measurement data in which the vibration of the structure is not reflected. For example, when a sensor has failure, it is impossible to acquire data such as accurate displacement at a portion to which the sensor is attached. For example, when a place to which a sensor is attached on the structure has an abnormality such as peeling, the sensor is unable to acquire measurement data consistent with measurement data acquired by a sensor attached to a place having no abnormality. Among the features of the vibration of the structure, the feature based on abnormal measurement data will be denoted as an outlier. When measurement data include an abnormal value and the feature of the vibration of the structure is represented by the above-described eigenvector, any of the elements of the eigenvector is an outlier.

When it is determined that the measured vibration of the structure does not have the feature of the vibration in the standard natural vibration mode of the structure, the detection unit 105 detects an outlier included in the feature of the measured vibration of the structure, by using the feature of the vibration in the standard natural vibration mode of the structure. Specifically, when the correlation value is smaller than the threshold value C, the detection unit 105 detects the outlier in the elements of the target eigenvector by using the target eigenvector and the standard eigenvector. The outlier in the elements of the target eigenvector is, for example, an element having a larger difference between the element of the target eigenvector and the element of the standard eigenvector of the same number than a difference in the elements of another number. The detection unit 105 may detect the outlier in the elements of the target eigenvector by using cross comparison to be described below specifically.

The detection unit 105 may calculate a MAC for two vectors excluding one element of the same order from the target eigenvector and the standard eigenvector, while varying the elements to be excluded from the first element to the last element. In the following description, the MAC for two vectors excluding the i-th (i=1, k) element will be denoted by MACᵢ. A natural number k is the number of sensors attached to the structure, that is, the number of elements of the target eigenvector and the standard eigenvector. The detection unit 105 may detect, among MAC₁ to MACₖ, a MAC (hereinafter, denoted by MACₘ (1≤m≤k)) being maximum and having another MAC being smaller than a predetermined threshold value (hereinafter, denoted as a threshold value C2). The threshold value C2 may be the same as the threshold value C. The detection unit 105 may simply detect the maximum MAC among MAC₁ to MACₖ. The detection unit 105 detects, as an outlier, a target eigenvector element excluded when the detected MACₖ is calculated. The detection unit 105 detects, as abnormal measurement data, measurement data in which the element specified as the outlier is calculated.

Specifically, the detection unit 105 first generates, from the standard eigenvector |ϕ>=^{t}(a₁, a₂, . . . , aᵢ₋₁, aᵢ, aᵢ₊₁, . . . , aₖ), a new standard eigenvector including elements other than the i-th element of the standard eigenvector in the same order as the order in the original standard eigenvector. The generated standard eigenvector |ϕᵢ> from which the i-th element aᵢ is excluded is |ϕᵢ>=^{t}(a₁, a₂, . . . , aᵢ₋₁, aᵢ₊₁, . . . , aₖ).

The detection unit 105 generates, from the target eigenvector |ψ>=^{t}(b₁, b₂, . . . , bᵢ₋₁, bᵢ, bᵢ₊₁, . . . , bₖ), a new target eigenvector including elements other than the i-th element of the target eigenvector in the same order as the order in the original target eigenvector. The generated target eigenvector |ψᵢ> from which the i-th element b, is excluded is |ψᵢ>=^{t}(b₁, b₂, . . . , bᵢ₋₁, bᵢ₊₁, . . . , bₖ). A natural number k is the number of elements of the eigenvector. A natural number i is equal to or less than k.

The detection unit 105 calculates a correlation MACᵢ between the updated standard eigenvector |ϕᵢ> and the updated target eigenvector. The detection unit 105 repeats an operation of excluding the i-th element from the original target eigenvector and the original standard eigenvector and calculating MACᵢ until i becomes the number k of elements of the eigenvector from 1, while incrementing i by one.

The number of elements to be excluded from each of the target eigenvector and the standard eigenvector is not limited to one. The detection unit 105 may exclude two or more elements, which is sufficiently smaller than the number k of elements of the eigenvector, from each of the target eigenvector and the standard eigenvector. The detection unit 105 may calculate a MAC between the target eigenvector and the standard eigenvector from which those elements are excluded. For example, when the number of elements to be excluded is two, the detection unit 105 calculates ₖC₂ ways of MACs.

The detection unit 105 detects an element being an outlier, by using the calculated k MACᵢ (i=1, 2, . . . , n). When, for example, MACₘ is maximum among MAC₁ to MACₖ and each of MACⱼ (j≠m) is equal to or less than the preliminarily determined threshold value C2, the detection unit 105 detects the m-th element as the outlier.

The detection unit 105 generates, from the standard eigenvector, an updated standard eigenvector from which the m-th element is excluded. The update unit 106 generates, from the target eigenvector, an updated target eigenvector from which the m-th element detected as the outlier is excluded.

In the examples illustrated in FIGS. 4 and 6, when the MAC is smaller than a threshold value, for example, the element of the value indicated by the black dot at X2 is equivalent to the outlier. In other words, the measurement data acquired by the sensor S2 are determined as the outlier.

The detection unit 105 may estimate the eigenfunction, for example, from the values of each element of the standard eigenvector by using, for example, maximum likelihood estimation. When a value of an element of the target eigenvector is not included within a margin of error for a value, at any of the positions of the elements of the standard eigenvector, of the estimated eigenfunction, the detection unit 105 may detect, as the outlier, the element whose value is not included within the margin of error.

The method of detecting an outlier described above is an example. The detection unit 105 may detect an outlier by using another method such as, for example, a Hoteling's method, and a method based on difference in a distribution of the elements of the eigenvector.

The update unit 106 updates the feature of the measured vibration of the structure in such a way as to become the feature of the vibration represented by the measurement dataset excluding the abnormal measurement data detected from the received measurement dataset. The update unit 106 further updates the feature in the standard natural vibration mode of the structure in such a way as to become the feature of the vibration represented by the standard dataset excluding, from the standard dataset, data at a place where the detected abnormal measurement data are acquired.

Specifically, the update unit 106 performs updating of excluding the detected outlier, from the elements of the target eigenvector. The update unit 106 further performs updating of excluding the element of the same order as the outlier, from the elements of the standard eigenvector. More specifically, the update unit 106 generates the target eigenvector from which the element being the outlier is excluded, and the standard eigenvector from which the element of the same number as the number of the element being the outlier is excluded. The update unit 106 may normalize the generated target eigenvector and the generated standard eigenvector. The update unit 106 may normalize each of the updated target eigenvector and the updated standard eigenvector. The update unit 106 sends the updated target eigenvector and the updated standard eigenvector to the comparison unit 103. Note that, when the detection unit 105 detects an outlier by using a MAC calculated from the target eigenvector and the standard eigenvector from which the element is excluded, the update unit 106 may be absent. In this case, the detection unit 105 may transmit, to the determination unit 104, the MAC calculated from the target eigenvector and the standard eigenvector from which the detected outlier is excluded.

When the comparison unit 103 receives the updated target eigenvector and the updated standard eigenvector from the update unit 106, the comparison unit 103 calculates a MAC between the received target eigenvector and the received standard eigenvector. The comparison unit 103 sends the calculated MAC to the determination unit 104.

In the above description, the update unit 106 generates the target eigenvector and the standard eigenvector from which the outlier is excluded. However, the update unit 106 may generate outlier data (for example, a list of numbers of elements determined as outliers) indicating an element being the outlier, and may transmit the generated outlier data to the comparison unit 103. In this case, the comparison unit 103 may calculate a correlation value such as a MAC by using elements other than the element indicated by the outlier data.

The determination unit 104 determines, on the basis of a result of comparison of the feature of the measured vibration of the structure based on the measurement dataset other than the abnormal measurement data, with the feature of the vibration in the standard natural vibration mode of the structure, whether the measured vibration of the structure has the feature of the vibration in the standard natural vibration mode of the structure. Specifically, when the correlation value (for example, the MAC) calculated by using elements other than the element indicated by the outlier data is greater than the predetermined threshold value C, the determination unit 104 determines that the vibration of the structure is the vibration in the standard natural vibration mode. When the correlation value (for example, the MAC) calculated by using elements other than the element indicated by the outlier data is equal to or less than the predetermined threshold value C, the determination unit 104 determines that the vibration of the structure is not the vibration in the standard natural vibration mode.

In the examples illustrated in FIGS. 4 and 6, the target eigenvector and the standard eigenvector from which the element of the value indicated by the black dot at the position indicated by X2 is excluded are generated. When the MAC representing the correlation between these vectors is greater than a predetermined value, it is determined that the vibration of the structure illustrated in FIG. 5 is the vibration in the standard natural vibration mode.

When it is determined that the measured vibration of the structure has the feature of the vibration in the standard natural vibration mode of the structure, that is, when it is determined that the vibration of the structure is the vibration in the standard natural vibration mode, the extraction unit 107 extracts another vibration characteristic in the natural vibration mode of the structure. The vibration characteristic is, for example, an eigenvector, a natural vibration frequency, and a damping rate. In this case, the another vibration characteristic is a natural vibration frequency and a damping rate. Specifically, the extraction unit 107 may extract, as a natural angular frequency, a value acquired by multiplying a peak frequency of a frequency spectrum in the measurement dataset by 2π. The frequency spectrum in the measurement dataset is frequency-domain data that can be acquired by transforming each piece of measurement data in the measurement dataset by performing Fourier transform in relation to time t. The extraction unit 107 may calculate, as a damping rate, a half width at half maximum of a peak value of the frequency spectrum in the measurement dataset. The extraction unit 107 may extract the vibration characteristic by using another method such as a method using linear predictive analysis.

When it is determined that the measured vibration of the structure does not have the feature of the vibration in the standard natural vibration mode of the structure, that is, when it is determined that the vibration of the structure is not the vibration in the standard natural vibration mode, the extraction unit 107 does not need to extract another vibration characteristic.

When it is determined that the vibration of the structure is the vibration in the standard natural vibration mode, that is, when another vibration characteristic of the structure is extracted, the output unit 108 may output the extracted vibration characteristic of the structure to, for example, the terminal device 300. The vibration characteristic of the structure is, for example, an eigenvector, a natural vibration frequency, and a damping rate. In this case, the output unit 108 may output, for example, to the terminal device 300, a message indicating that the vibration of the structure is the vibration in the standard natural vibration mode.

When it is determined that the vibration of the structure is not the vibration in the standard natural vibration mode, that is, when another vibration characteristic of the structure is not extracted, the output unit 108 does not need to output any vibration characteristic. In this case, the output unit 108 may output, for example, to the terminal device 300, a message indicating that the vibration of the structure is not the vibration in the standard natural vibration mode.

[Description of Operation]

Next, an operation of the vibration determination device 100 according to the present example embodiment will be described in detail with reference to the drawings.

First, a preparation operation of the vibration determination device 100 will be described.

FIG. 7 is a flowchart representing an example of an operation of the vibration determination device 100 according to the present example embodiment. The operation illustrated in FIG. 7 represents an operation of calculating a feature (that is, a standard eigenvector) of a vibration in a standard natural vibration mode from a plurality of series of standard data (that is, the above-described standard dataset).

First, the acceptance unit 101 accepts a standard dataset, that is, a plurality of series of standard measurement values (Step S101). Then, the calculation unit 102 calculates, from the standard dataset, a feature (that is, a standard eigenvector) of a vibration in a standard natural vibration mode (Step S102). The comparison unit 103 stores the calculated feature (that is, the standard eigenvector) of the vibration in the standard natural vibration mode (Step S103).

Next, an overall operation of the vibration determination device 100 will be described.

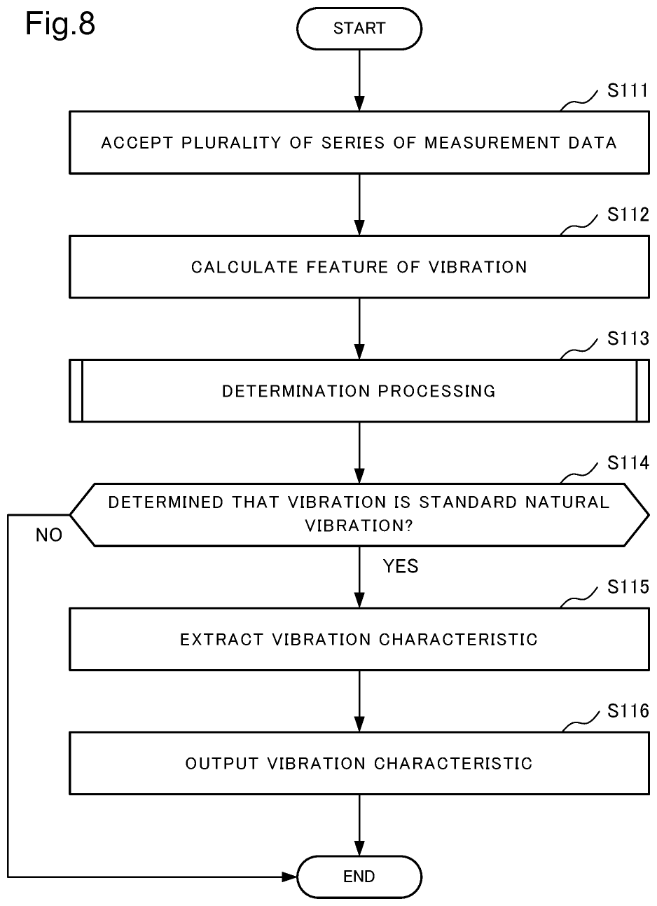

FIG. 8 is a flowchart representing an example of an operation of the vibration determination device 100 according to the present example embodiment.

First, the acceptance unit 101 accepts a plurality of series of measurement data (that is, a measurement dataset) (Step S111). The calculation unit 102 calculates, from the plurality of series of measurement data (that is, the measurement dataset), a feature (that is, a target eigenvector) of a vibration of a structure (Step S112).

Then, the vibration determination device 100 performs determination processing (Step S113). The operation of determination processing in Step S113 will be described later in detail. The vibration determination device 100 determines, through the operation of determination processing in Step S113, whether the vibration of the structure for which the accepted plurality of series of measurement data have been acquired is a standard natural vibration, that is, whether the vibration of the structure is a vibration in a standard natural vibration mode.

When it is determined that the vibration is the standard natural vibration (YES in Step S114), the extraction unit 107 extracts a vibration characteristic (Step S115). Then, the output unit 108 outputs the vibration characteristic (Step S116). In Step S116, the output unit 108 may output, as a result of determination, a message or the like indicating that the vibration is the standard natural vibration.

When it is not determined that the vibration is the standard natural vibration (NO in Step S114), the vibration determination device 100 ends the operation illustrated in FIG. 8. Before the end of the operation illustrated in FIG. 8, the output unit 108 may output, as a result of determination, a message or the like indicating that the vibration is not the standard natural vibration.

Next, an operation of determination processing performed by the vibration determination device 100 will be described.

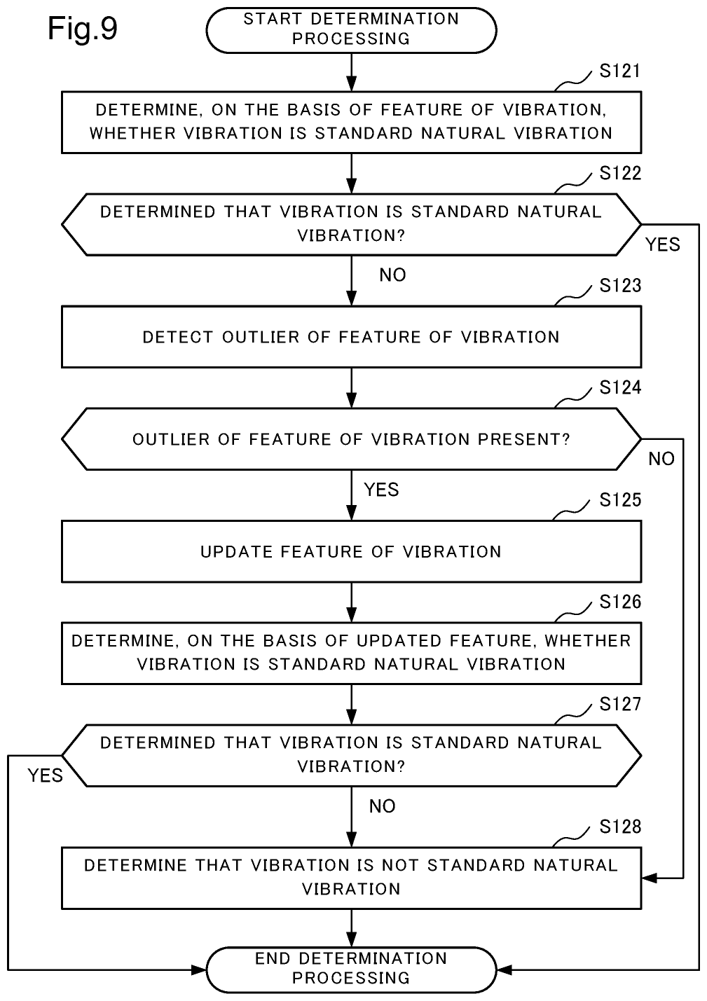

FIG. 9 is a flowchart representing an example of an operation of determination processing performed by the vibration determination device 100 according to the present example embodiment.

The comparison unit 103 and the determination unit 104 determine whether the vibration is a standard natural vibration on the basis of the feature (that is, the target eigenvector) of the vibration (Step S121). Specifically, the comparison unit 103 calculates a correlation value (for example, the above-described MAC) between the eigenvector and the standard eigenvector. When the calculated correlation value is greater than a predetermined threshold value C, the determination unit 104 determines that the vibration is the standard natural vibration. When the calculated correlation value is equal to or less than the predetermined threshold value C, the determination unit 104 does not determine that the vibration is the standard natural vibration.

When it is determined that the vibration is the standard natural vibration (YES in Step S122), the vibration determination device 100 ends the operation illustrated in FIG. 9.

When it is not determined that the vibration is the standard natural vibration (NO in Step S122), the detection unit 105 detects an abnormal value of the feature of the vibration (Step S123). Specifically, the detection unit 105 detects, as the abnormal value of the feature of the vibration, an outlier in elements of the target eigenvector, as described above. When the abnormal value of the feature of the vibration is absent (NO in Step S124), that is, when no abnormal value of the feature of the vibration is detected, the determination unit 104 determines that the vibration is not the standard natural vibration (Step S128).

When the abnormal value of the feature of the vibration is present (YES in Step S124), that is, when the abnormal value of the feature of the vibration is detected, the update unit 106 updates the feature of the vibration in such a way that the feature of the vibration does not include the detected abnormal value (Step S125). Specifically, the update unit 106 generates, for example, an eigenvector that includes the elements of the pre-update eigenvector other than the element being the outlier in the same order as the order in the pre-update eigenvector, and that does not include the element being the outlier. In Step S125, the update unit 106 further updates the feature of the standard natural vibration in such a way as not to include a value calculated from a measurement value measured by a sensor that has measured the measurement value for which the detected abnormal value is calculated. Specifically, the update unit 106 generates, for example, a standard eigenvector that includes the elements of the pre-update standard eigenvector other than the element of the same number as the element being the outlier in the same order as the order in the pre-update standard eigenvector, and that does not include the element of the same number as the element being the outlier.

The comparison unit 103 and the determination unit 104 determine, on the basis of the updated feature (that is, the target eigenvector) of the vibration, whether the vibration is the standard natural vibration (Step S126). Specifically, the comparison unit 103 calculates a correlation value (for example, the above-described MAC) between the post-update eigenvector and the post-update standard eigenvector. When the calculated correlation value is greater than the predetermined threshold value C, the determination unit 104 determines that the vibration is the standard natural vibration.

When it is determined that the vibration is the standard natural vibration (YES in Step S127), the vibration determination device 100 ends the operation of determination processing illustrated in FIG. 9.

When the calculated correlation value is equal to or less than the predetermined threshold value C, that is, when it is not determined that the vibration is the standard natural vibration (NO in Step S127), the determination unit 104 determines that the vibration is not the standard natural vibration (Step S128). Then, the vibration determination device 100 ends the operation of determination processing illustrated in FIG. 9.

[Description of Advantageous Effect]

Next, an advantageous effect of the present example embodiment will be described.

The present example embodiment has an advantageous effect of improving vibration determination performance when measurement values of a vibration include an abnormality. The reason is that, when it is not determined that a vibration of a structure is a standard natural vibration, the detection unit 105 detects an abnormal value in a feature of the vibration of the structure. The determination unit 104 determines whether the vibration of the structure is the standard natural vibration on the basis of the feature of the vibration of the structure excluding the detected abnormal value. Thus, a possibility is reduced that the vibration of the structure is determined as not being the standard natural vibration because the feature of the vibration includes an abnormal value caused by an abnormality of a sensor or a place to which the sensor is attached, although the vibration of the structure is the standard natural vibration. In other words, vibration determination performance when measurement values of a vibration include an abnormality is improved.

### Second Example Embodiment

Next, a second example embodiment according to the present disclosure will be described in detail with reference to the drawings.

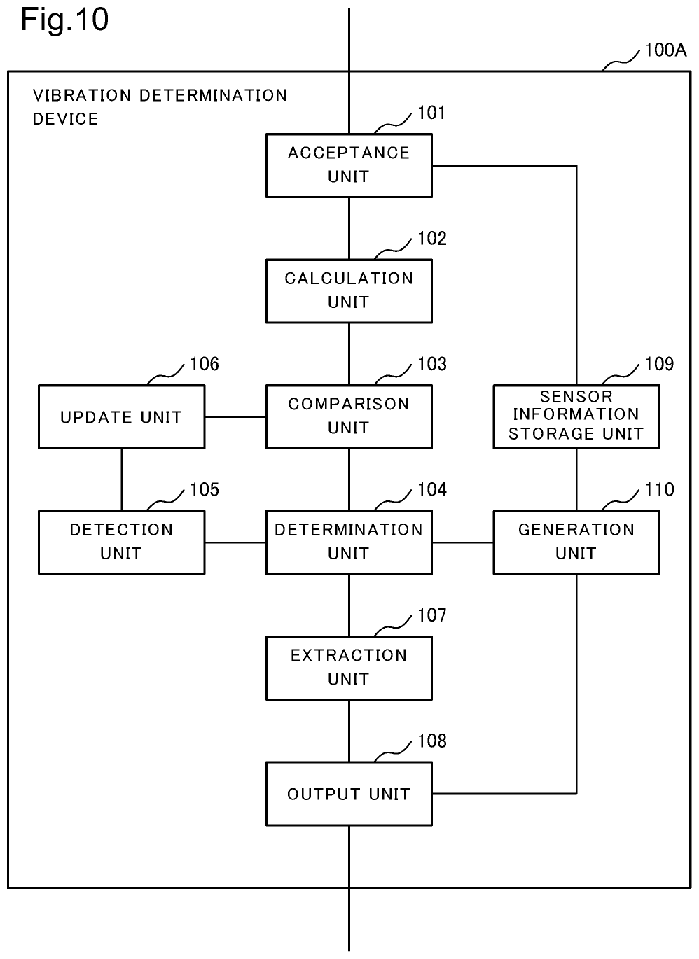

FIG. 10 is a block diagram representing an example of a configuration of a vibration determination device 100A according to the present example embodiment. The vibration determination device 100A illustrated in FIG. 10 includes an acceptance unit 101, a calculation unit 102, a comparison unit 103, a determination unit 104, a detection unit 105, an update unit 106, an extraction unit 107, an output unit 108, a sensor information storage unit 109, and a generation unit 110.

The acceptance unit 101, the calculation unit 102, the comparison unit 103, the determination unit 104, the detection unit 105, the update unit 106, the extraction unit 107, and the output unit 108 perform the same operations as the operations of the units assigned with the same names according to the first example embodiment, except for a difference described below.

The acceptance unit 101 further receives information on a position to which a sensor is attached. The acceptance unit 101 may receive, as the information on the position to which the sensor is attached, for example, information representing the shape of a structure and information on the position of the sensor on the structure. The information representing the shape of the structure may be, for example, a three-dimensional model of the structure. The information representing the shape of the structure may be an image on which the shape of the structure is projected. The acceptance unit 101 stores, in the sensor information storage unit 109, the received information on the position to which the sensor is attached.

The sensor information storage unit 109 stores the information on the position to which the sensor is attached.

The detection unit 105 may further detect, as abnormal measurement data, measurement data included in a measurement dataset and from which an outlier in a feature of a vibration of the structure is derived. The abnormal measurement data represent the measurement data from which the outlier in the feature of the vibration of the structure is derived. Specifically, the detection unit 105 may specify, as the abnormal measurement data, measurement data from which an element detected as the outlier of the above-described target eigenvector is derived. The detection unit 105 may further specify, as an abnormal sensor, a sensor that has acquired the abnormal measurement data. The detection unit 105 may send, for example, to the determination unit 104, information specifying the measurement data detected as the abnormal measurement data. The detection unit 105 may send, for example, to the determination unit 104, information specifying the sensor specified as the abnormal sensor. The information specifying the abnormal sensor may be the information specifying the measurement data detected as the abnormal measurement data.

When it is determined that the vibration of the structure is a vibration in a standard natural vibration mode, and also an abnormal value of the feature of the vibration is detected, the determination unit 104 may send the measurement data detected as the abnormal measurement data to the output unit 108, for example, via the extraction unit 107. When it is determined that the vibration of the structure is a vibration in a standard natural vibration mode, and when an abnormal value of the feature of the vibration is detected, the determination unit 104 may send the information specifying the abnormal sensor to the generation unit 110.

The generation unit 110 receives the information specifying the abnormal sensor, for example, from the determination unit 104. The generation unit 110 generates, on the basis of the information specifying the abnormal sensor, and the information representing the position to which the sensor is attached, which is stored in the sensor information storage unit 109, information specifying a place where the abnormal measurement data that are measured by the abnormal sensor are measured. The generation unit 110 may generate, as the information specifying the place where the abnormal measurement data are measured, information representing a place to which the abnormal sensor is attached. The information specifying the place where the abnormal measurement data are measured may be, for example, the information specifying the abnormal sensor. The information representing the place to which the abnormal sensor is attached is, for example, an image of the structure, with a mark indicating the place to which the abnormal sensor is attached being superimposed on a position equivalent to the place to which the abnormal sensor is attached. The mark indicating the place to which the abnormal sensor is attached will be also denoted as a mark indicating the abnormal sensor. The mark may be, for example, a circle, a polygon such as a triangle or a square, an arrow, or another shape. The mark may be a + mark, an X mark, a character, or a character string. The mark may be a combination of a shape and one or a plurality of characters. The mark is not limited to the above examples. The mark may be flickering. The generation unit 110 may superimpose, on the image of the structure, the mark indicating a sensor not detected as the abnormal sensor. In this case, the generation unit 110 may superimpose, on the image of the structure, the mark indicating the abnormal sensor, in a display format different in at least any of color, size, and motion from a display format of the mark indicating the sensor not detected as the abnormal sensor.

The output unit 108 may receive the information specifying the measurement data detected as the abnormal data, from the determination unit 104, for example, via the extraction unit 107. The output unit 108 may output, for example, to the terminal device 300 or the like, the information specifying the measurement data detected as the abnormal measurement data.

The output unit 108 may receive, from the generation unit 110, the information specifying the place where the abnormal measurement data are measured, and may output, for example, to the terminal device 300 or the like, the received information specifying the place where the abnormal measurement data are measured.

[Description of Operation]

Next, an operation of the vibration determination device 100A according to the present example embodiment will be described in detail with reference to the drawings.

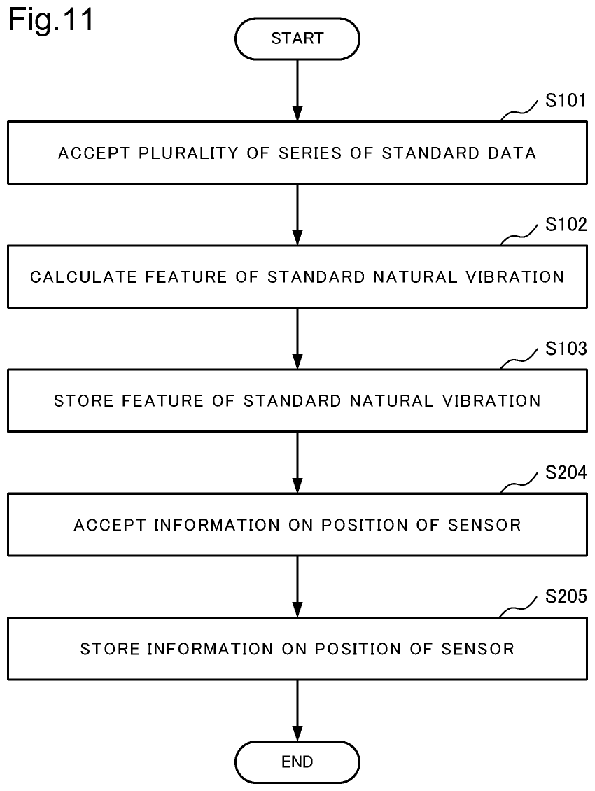

FIG. 11 is a flowchart representing an example of an operation of the vibration determination device 100A according to the present example embodiment. The operation illustrated in FIG. 11 represents an initial operation of the vibration determination device 100A. In the operation illustrated in FIG. 11, the vibration determination device 100A accepts information on a position of a sensor, as well as calculating a feature (that is, a standard eigenvector) of a vibration in a standard natural vibration mode from a plurality of series of standard data (that is, the above-described standard dataset).

The operations from Step S101 to Step S103 in FIG. 11 are the same as the operations from Step S101 to Step S103 according to the first example embodiment, which are illustrated in FIG. 7.

Then, the acceptance unit 101 accepts information on a position of a sensor (Step S204). The acceptance unit 101 stores, in the sensor information storage unit 109, the accepted information on the position of the sensor (Step S205).

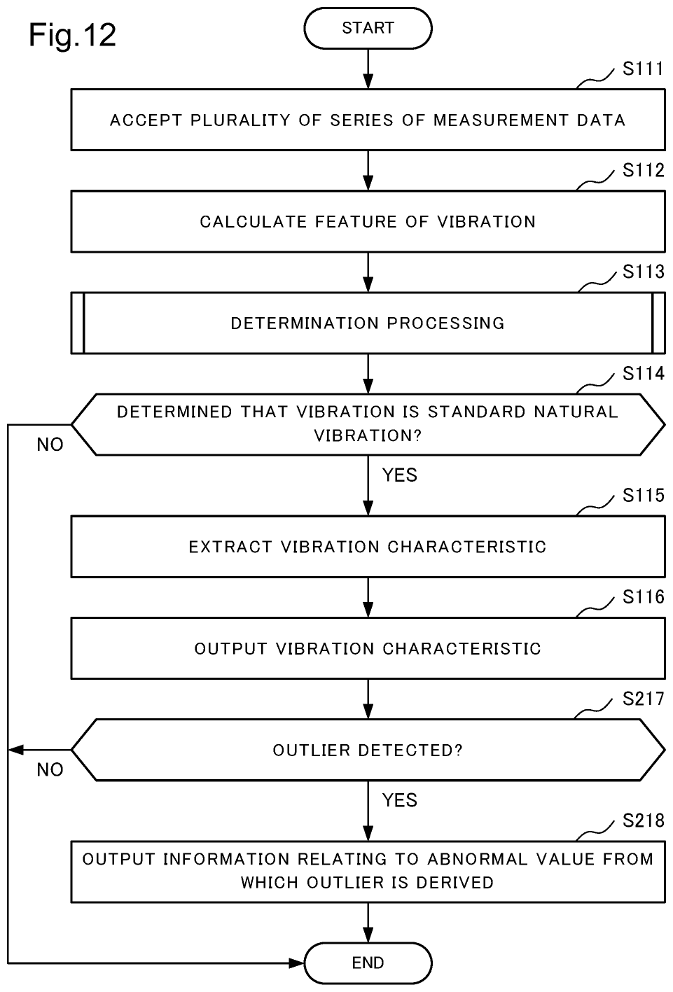

FIG. 12 is a flowchart representing an example of an overall operation of the vibration determination device 100A according to the present example embodiment. The operations from Step S111 to Step S116 in FIG. 12 are the same as the operations from Step S111 to Step S116, respectively, which are illustrated in FIG. 8.

When it is determined that the vibration of the structure is a standard natural vibration and, further, an outlier is detected in the feature of the vibration of the structure (YES in Step S217), the output unit 218 outputs information relating to an abnormal value from which the outlier is derived. The information relating to the abnormal value from which the outlier is derived may be, for example, the above-described information specifying the abnormal measurement data. The information relating to the abnormal value from which the outlier is derived may be, for example, the information specifying the abnormal sensor. The information relating to the abnormal value from which the outlier is derived may be information relating to a place where the abnormal value from which the outlier is derived is measured. The information relating to the place where the abnormal value from which the outlier is derived is measured may be information relating to a place to which the abnormal sensor is attached. The information relating to the place to which the abnormal sensor is attached may be an image of the structure on which a mark indicating a place of the abnormal sensor is superimposed.

When the outlier is detected in the feature of the vibration of the structure (NO in Step S217), the vibration determination device 100A ends the operation illustrated in FIG. 12.

[Description of Advantageous Effect]

The present example embodiment has the same advantageous effect as the advantageous effect of the first example embodiment. The reason is the same as the reason why the advantageous effect of the first example embodiment is produced.

The present example embodiment further has an advantageous effect of making it easy to find an abnormality occurring in a sensor and a structure. The reason is that the generation unit 110 generates information specifying measurement data detected as abnormal data. The information specifying the measurement data detected as the abnormal data is output by the output unit 108.

### Third Example Embodiment

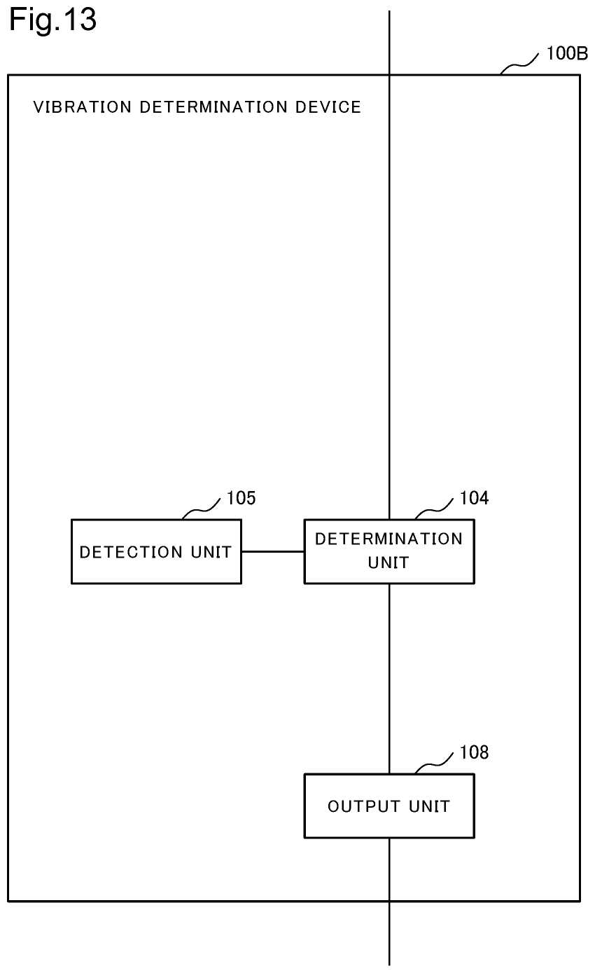

FIG. 13 is a block diagram representing a configuration of a vibration determination device 100B according to a third example embodiment of the present disclosure.

The vibration determination device 100B illustrated in FIG. 13 includes a determination unit 104, a detection unit 105, and an output unit 108.

The determination unit 104 determines, on the basis of a plurality of feature values representing features of a vibration of a structure, whether the vibration of the structure is a standard vibration. The plurality of feature values representing the features of the vibration of the structure are, for example, the above-described eigenvector (that is, a plurality of elements of the above-described eigenvector). The standard vibration is a vibration in the above-described standard natural vibration mode. The determination unit 104 may determine whether the vibration of the structure is the standard vibration, according to the same method as the method used by the determination unit 104 according to the first example embodiment and the second example embodiment.

When it is not determined that the vibration of the structure is the standard vibration, the detection unit 105 detects an outlier included in the plurality of feature values. The detection unit 105 may detect the outlier according to the same method as the method used by the detection unit 105 according to the first example embodiment and the second example embodiment.

The determination unit 104 further determines, on the basis of feature values other than the detected outlier among the plurality of feature values, whether the above-described vibration of the structure is the standard vibration.

The output unit 108 outputs whether the vibration of the structure is the standard vibration. In other words, the output unit 108 outputs information indicating whether the vibration of the structure is the standard vibration. In still other words, when it is determined in any of Steps S302 and S304 that the vibration is the standard vibration, the output unit 108 outputs information indicating that the vibration of the structure is the standard vibration. The information indicating that the vibration of the structure is the standard vibration may be a text message. The information indicating that the vibration of the structure is the standard vibration may be a preliminarily determined value. When it is not determined in Step S304 that the vibration of the structure is the standard vibration, the output unit 108 outputs information indicating that the vibration of the structure is not the standard vibration. The information indicating that the vibration of the structure is not the standard vibration may be a text message. The information indicating that the vibration of the structure is not the standard vibration may be a preliminarily determined value different from the value indicating that the vibration of the structure is the standard vibration.

[Description of Operation]

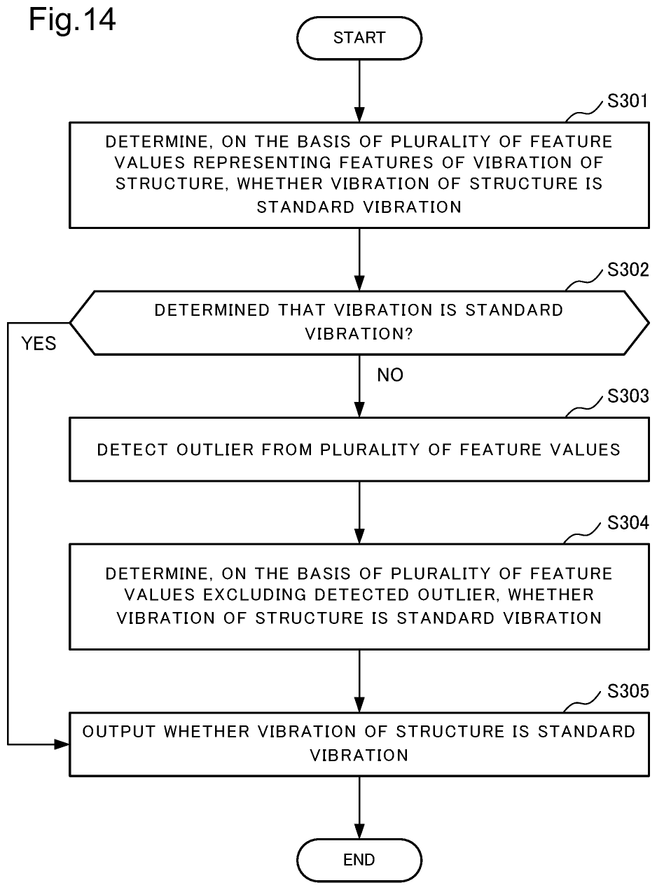

FIG. 14 is a flowchart representing an example of an operation of the vibration determination device 100B according to the present example embodiment.

First, the determination unit 104 determines, on the basis of a plurality of feature values representing features of a vibration of a structure, whether the vibration of the structure is a standard vibration (Step S301). When it is determined that the vibration is the standard vibration (YES in Step S302), the vibration determination device 100B then performs the operation of Step S305. When it is not determined that the vibration is the standard vibration (NO in Step S302), the detection unit 105 detects an outlier from the plurality of feature values (Step S303). The determination unit 104 further determines, on the basis of the plurality of feature values excluding the detected outlier, whether the vibration of the structure is the standard vibration (Step S304).

Then, the output unit 108 outputs whether the vibration of the structure is the standard vibration (Step S305).

[Description of Advantageous Effect]

The present example embodiment has the same advantageous effect as the advantageous effect of the first example embodiment. The reason is the same as the reason why the advantageous effect of the first example embodiment is produced.

### Another Example Embodiment

The vibration determination device according to the above-described example embodiments can be achieved by a computer that includes a memory on which a program read out from a storage medium is loaded and a processor executing the program. The vibration determination device according to the above-described example embodiments can be also achieved by dedicated hardware. The vibration determination device according to the above-described example embodiments can be also achieved by a combination of the above-described computer and the above-described dedicated hardware.

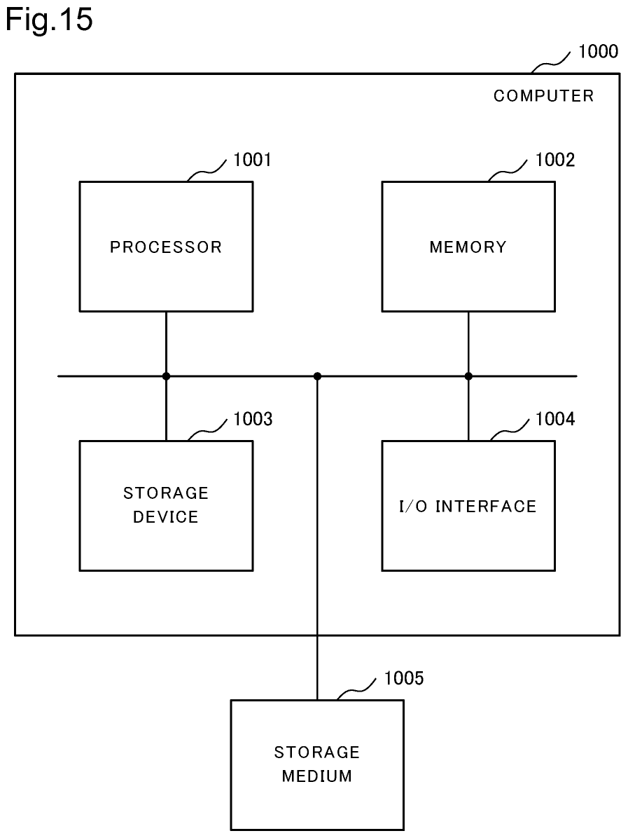

FIG. 15 is a diagram representing one example of a hardware configuration of a computer 1000 that can achieve the vibration determination device according to the example embodiments of the present disclosure. Referring to FIG. 15, the computer 1000 includes a processor 1001, a memory 1002, a storage device 1003, and an input/output (I/O) interface 1004. The computer 1000 is able to access a storage medium 1005. The memory 1002 and the storage device 1003 are, for example, a random access memory (RAM) and a storage device such as a hard disk. The storage medium 1005 is, for example, a RAM, a storage device such as a hard disk, a read only memory (ROM), or a portable storage medium. The storage device 1003 may be the storage medium 1005. The processor 1001 is able to perform reading and writing of data or a program on the memory 1002 and the storage device 1003. The processor 1001 is able to communicate with, for example, the data logger 200 and the terminal device 300 via the I/O interface 1004. The processor 1001 is able to access the storage medium 1005. The storage medium 1005 stores a program that causes the computer 1000 to operate as the vibration determination device 100, the vibration determination device 100A, or the vibration determination device 100B.

The processor 1001 loads, on the memory 1002, the program that is stored in the storage medium 1005 and causes the computer 1000 to operate as the vibration determination device 100, the vibration determination device 100A, or the vibration determination device 100B. Then, when the processor 1001 executes the program loaded on the memory 1002, the computer 1000 operates as the vibration determination device 100, the vibration determination device 100A, or the vibration determination device 100B.

The acceptance unit 101, the calculation unit 102, the comparison unit 103, the determination unit 104, the detection unit 105, the update unit 106, the extraction unit 107, and the output unit 108 can be achieved by, for example, the processor 1001 that executes a dedicated program loaded on the memory 1002. The generation unit 110 can be also achieved by, for example, the processor 1001 that executes a dedicated program loaded on the memory 1002. The sensor information storage unit 109 can be achieved by the memory 1002 or the storage device 1003 such as a hard disk device, which are included in the computer 1000. Some or all of the acceptance unit 101, the calculation unit 102, the comparison unit 103, the determination unit 104, the detection unit 105, the update unit 106, the extraction unit 107, and the output unit 108 can be also achieved by a dedicated circuit implementing functions of the units. Some or all of the sensor information storage unit 109 and the generation unit 110 can be also achieved by a dedicated circuit implementing the functions of the units.

Some or all of the above-described example embodiments can be also described as the following supplementary notes, but are not limited to the following.

(Supplementary Note 1)

A vibration determination device including:

determination means for determining, based on a plurality of feature values representing features of a vibration of a structure, whether the vibration of the structure is a standard vibration; and

detection means for detecting, when it is not determined that the vibration of the structure is the standard vibration, an outlier included in the plurality of feature values, wherein

the determination means further determines, based on the plurality of feature values other than the detected outlier, whether the vibration of the structure is the standard vibration, and

the vibration determination device further includes

output means for outputting whether the vibration of the structure is the standard vibration.

(Supplementary Note 2)

The vibration determination device according to Supplementary Note 1, wherein

each of the plurality of feature values represents a feature of a vibration measured at a different place on the structure, and

the output means further outputs information relating to a place where the feature of the vibration indicated by the feature value detected as the outlier is measured.

(Supplementary Note 3)

The vibration determination device according to Supplementary Note 2, wherein the output means outputs information specifying an abnormal sensor being a sensor installed at a place where the feature of the vibration indicated by the feature value detected as the outlier is measured.

(Supplementary Note 4)

The vibration determination device according to Supplementary Note 3, wherein

the output means outputs an image of the structure on which a mark indicating a place of the abnormal sensor attached to the structure is superimposed.

(Supplementary Note 5)

The vibration determination device according to any one of Supplementary Notes 1 to 4, wherein

the detection means detects the selected feature value as the outlier when it is determined, based on the plurality of feature values other than a selected feature value selected from the plurality of feature values, that the vibration of the structure is the standard vibration.

(Supplementary Note 6)

A vibration determination method including:

determining, based on a plurality of feature values representing features of a vibration of a structure, whether the vibration of the structure is a standard vibration;

detecting, when it is not determined that the vibration of the structure is the standard vibration, an outlier included in the plurality of feature values;

determining, based on the plurality of feature values other than the detected outlier, whether the vibration of the structure is the standard vibration; and

outputting whether the vibration of the structure is the standard vibration.

(Supplementary Note 7)

The vibration determination method according to Supplementary Note 6, wherein

each of the plurality of feature values represents a feature of a vibration measured at a different place on the structure, and the outputting further includes outputting information relating to a place where the feature of the vibration indicated by the feature value detected as the outlier is measured.

(Supplementary Note 8)

The vibration determination method according to Supplementary Note 7, including

outputting information specifying an abnormal sensor being a sensor installed at a place where the feature of the vibration indicated by the feature value detected as the outlier is measured.

(Supplementary Note 9)

The vibration determination method according to Supplementary Note 8, including

outputting an image of the structure on which a mark indicating a place of the abnormal sensor attached to the structure is superimposed.

(Supplementary Note 10)

The vibration determination method according to any one of Supplementary Notes 6 to 9, wherein

detecting the selected feature value as the outlier when it is determined, based on the plurality of feature values other than a selected feature value selected from the plurality of feature values, that the vibration of the structure is the standard vibration.

(Supplementary Note 11)

A storage medium storing a program causing a computer to execute:

determination processing of determining, based on a plurality of feature values representing features of a vibration of a structure, whether the vibration of the structure is a standard vibration; and

detection processing of detecting, when it is not determined that the vibration of the structure is the standard vibration, an outlier included in the plurality of feature values, wherein

the determination processing further determines, based on the plurality of feature values other than the detected outlier, whether the vibration of the structure is the standard vibration, and

the program further causes a computer to execute

output processing of outputting whether the vibration of the structure is the standard vibration.

(Supplementary Note 12)

The storage medium according to Supplementary Note 11, wherein

each of the plurality of feature values represents a feature of a vibration measured at a different place on the structure, and

the output processing further outputs information relating to a place where the feature of the vibration indicated by the feature value detected as the outlier is measured.

(Supplementary Note 13)

The storage medium according to Supplementary Note 12, wherein

the output processing outputs information specifying an abnormal sensor being a sensor installed at a place where the feature of the vibration indicated by the feature value detected as the outlier is measured.

(Supplementary Note 14)

The storage medium according to Supplementary Note 13, wherein

the output processing outputs an image of the structure on which a mark indicating a place of the abnormal sensor attached to the structure is superimposed.

(Supplementary Note 15)

The storage medium according to any one of Supplementary Notes 11 to 14, wherein

the detection processing detects the selected feature value as the outlier when it is determined, based on the plurality of feature values other than a selected feature value selected from the plurality of feature values, that the vibration of the structure is the standard vibration.

In the above, the present invention has been described with reference to the example embodiments. However, the present invention is not limited to the above-described example embodiments. Various modifications that can be understood by a person skilled in the art may be made in the configurations and details of the present invention within the scope of the present invention.

### INDUSTRIAL APPLICABILITY

The present invention is applicable to mode determination and extraction of a structure such as a bridge.

### REFERENCE SIGNS LIST

1 Vibration determination system

100 Vibration determination device

100A Vibration determination device

100B Vibration determination device

101 Acceptance unit

102 Calculation unit

103 Comparison unit

104 Determination unit

105 Detection unit

106 Update unit

107 Extraction unit

108 Output unit

109 Sensor information storage unit

110 Generation unit

200 Data logger

201 Reception unit

202 Storage unit

203 Transmission unit

300 Terminal device

1000 Computer

1001 Processor

1002 Memory

1003 Storage device

1004 I/O interface

1005 Storage medium

1. A vibration determination device comprising:
at least one memory storing a set of instructions; and
at least one processor configured to execute the set of instructions to:
determine, based on a plurality of feature values representing features of a vibration of a structure, whether the vibration of the structure is a standard vibration; and
detect, when it is not determined that the vibration of the structure is the standard vibration, an outlier included in the plurality of feature values;
determine, based on the plurality of feature values other than the detected outlier, whether the vibration of the structure is the standard vibration; and
output whether the vibration of the structure is the standard vibration.

2. The vibration determination device according to claim 1, wherein
each of the plurality of feature values represents a feature of a vibration measured at a different place on the structure, and
the at least one processor is further configured to execute the set of instructions to
output information relating to a place where the feature of the vibration indicated by the feature value detected as the outlier is measured.

3. The vibration determination device according to claim 2, wherein
the at least one processor is further configured to execute the set of instructions to
output information specifying an abnormal sensor being a sensor installed at a place where the feature of the vibration indicated by the feature value detected as the outlier is measured.

4. The vibration determination device according to claim 3, wherein
the at least one processor is further configured to execute the set of instructions to
output an image of the structure on which a mark indicating a place of the abnormal sensor attached to the structure is superimposed.

5. The vibration determination device according claim 1, wherein
the at least one processor is further configured to execute the set of instructions to
detect the selected feature value as the outlier when it is determined, based on the plurality of feature values other than a selected feature value selected from the plurality of feature values, that the vibration of the structure is the standard vibration.

6. A vibration determination method comprising:
determining, based on a plurality of feature values representing features of a vibration of a structure, whether the vibration of the structure is a standard vibration;
detecting, when it is not determined that the vibration of the structure is the standard vibration, an outlier included in the plurality of feature values;
determining, based on the plurality of feature values other than the detected outlier, whether the vibration of the structure is the standard vibration; and
outputting whether the vibration of the structure is the standard vibration.

7. The vibration determination method according to claim 6, wherein
each of the plurality of feature values represents a feature of a vibration measured at a different place on the structure, and
the outputting further includes outputting information relating to a place where the feature of the vibration indicated by the feature value detected as the outlier is measured.

8. The vibration determination method according to claim 7, comprising
outputting information specifying an abnormal sensor being a sensor installed at a place where the feature of the vibration indicated by the feature value detected as the outlier is measured.

9. The vibration determination method according to claim 8, comprising
outputting an image of the structure on which a mark indicating a place of the abnormal sensor attached to the structure is superimposed.

10. The vibration determination method according to claim 6, wherein
detecting the selected feature value as the outlier when it is determined, based on the plurality of feature values other than a selected feature value selected from the plurality of feature values, that the vibration of the structure is the standard vibration.

11. A non-transitory computer-readable storage medium storing a program causing a computer to execute:
determination processing of determining, based on a plurality of feature values representing features of a vibration of a structure, whether the vibration of the structure is a standard vibration; and
detection processing of detecting, when it is not determined that the vibration of the structure is the standard vibration, an outlier included in the plurality of feature values, wherein
the determination processing further determines, based on the plurality of feature values other than the detected outlier, whether the vibration of the structure is the standard vibration, and
the program further causes a computer to execute
output processing of outputting whether the vibration of the structure is the standard vibration.

12. The storage medium according to claim 11, wherein
each of the plurality of feature values represents a feature of a vibration measured at a different place on the structure, and
the output processing further outputs information relating to a place where the feature of the vibration indicated by the feature value detected as the outlier is measured.

13. The storage medium according to claim 12, wherein
the output processing outputs information specifying an abnormal sensor being a sensor installed at a place where the feature of the vibration indicated by the feature value detected as the outlier is measured.

14. The storage medium according to claim 13, wherein
the output processing outputs an image of the structure on which a mark indicating a place of the abnormal sensor attached to the structure is superimposed.

15. The storage medium according to claim 11, wherein
the detection processing detects the selected feature value as the outlier when it is determined, based on the plurality of feature values other than a selected feature value selected from the plurality of feature values, that the vibration of the structure is the standard vibration.
